(19) United States
(12) Patent Application Publication
(10) Pub. No.: US 2021/0354223 A1
(43) Pub. Date: Nov. 18, 2021

(54) METHOD FOR MANUFACTURING A HEAT EXCHANGER COMPRISING A TEMPERATURE PROBE

(71) Applicant: L'Air Liquide, Société Anonyme pour l'Etude et l'Exploitation des Procédés Georges Claude, Paris (FR)

(72) Inventors: Jacopo SEIWERT, Versailles (FR); Marc WAGNER, Saint Maur des Fosses (FR); Marie-Adelaide CREMIEUX, Jouy-en-Josas (FR); Younes BELMEKKI, Vélizy-Villacoublay (FR)

(21) Appl. No.: 17/320,747

(22) Filed: May 14, 2021

(30) Foreign Application Priority Data
May 15, 2020 (FR) 2004867

(51) Int. Cl. B23K 1/00; F28D 9/00; F28F 3/02; F28F 27/00; F28F 21/08

(52) U.S. Cl. CPC B23K 1/0012; F28D 9/0043; F28F 2275/04; F28F 27/00; F28F 21/084; F28F 3/025

(57) ABSTRACT

The invention relates to a method for manufacturing a heat exchanger of the brazed plate and fin type, including: stacking, with spacing, a set of plates parallel to each other and in a longitudinal direction so as to define, between said plates, a plurality of passages adapted for the flow, in the longitudinal direction, of a first fluid to be brought into a heat exchange relationship with at least one second fluid, said plates being demarcated by a pair of longitudinal edges extending in the longitudinal direction and a pair of lateral edges extending in a lateral direction perpendicular to the longitudinal direction.

### CROSS REFERENCE TO RELATED APPLICATIONS

This application claims the benefit of priority under 35 U.S.C. § 119 (a) and (b) to French Patent Application No. 2004867, filed May 15, 2020, the entire contents of which are incorporated herein by reference.

### BACKGROUND

The present invention relates to a method for manufacturing a heat exchanger of the brazed plate type comprising at least one temperature probe allowing temperature and/or thermal flow measurements to be taken inside the exchanger, as well as to a heat exchanger allowing these measurements to be taken.

The present invention is particularly applicable in the field of cryogenic separation of gases, in particular the cryogenic separation of air, in what is known as an ASU (Air Separation Unit) that is used to produce pressurized gaseous oxygen. In particular, the present invention can be applied to the manufacture of a heat exchanger that vaporizes a flow of liquid, for example, liquid oxygen, nitrogen and/or argon by exchanging heat with a gaseous flow, for example, air or nitrogen.

The present invention also can be applied to a heat exchanger that vaporizes at least one flow of a liquid-gas mixture, in particular a flow of a multi-constituent mixture, for example, a mixture of hydrocarbons, by exchanging heat with at least one other fluid, for example, natural gas.

A technology that is commonly employed for heat exchangers is that of brazed plate exchangers, which allow highly compact components to be obtained providing a large exchange surface area and low pressure losses. These exchangers are formed by a set of parallel plates, between which spacing elements are generally inserted, such as corrugated or undulated structures, which form fin heat exchange structures. The stacked plates together form a stack of flat passages for different fluids to be brought into a heat exchange relationship.

When manufacturing the exchanger, the plates, the fin spacing elements and the other elements forming the exchanger are pressed one against the other and are subsequently connected together by brazing in a vacuum furnace at temperatures that can range between 550 and 900° C.

Due to their compactness and their monolithic construction, it is very difficult to perform local measurements of temperatures or of heat flows inside these brazed exchangers. Thus, in the vast majority of the methods in which they are implemented, the operator only has access to the total thermal power exchanged between fluids, by virtue of an energy balance that is achieved between the input and the output of each fluid.

This makes it very difficult to characterize these exchangers and does not allow, for example, isolated measurement of the heat exchange coefficient of each of the passages.

During use, the lack of local data limits the control possibilities of the method. In particular, certain particular physical phenomena that can occur inside the exchanger, such as phase changes or chemical reactions, are expressed by a local variation of the heat flow or of the temperature, which also depends on the position considered in the exchanger.

The local measurement of temperatures or of heat flows would allow on-site detection of poor operating conditions of the exchangers: poor distribution of the fluids, reduction in the performance of certain zones of the exchanger due, for example, to blocking or local distillation phenomena. It also would be worthwhile benefiting from local measurements of temperatures or of heat flows in order to monitor the evolution of the performance capabilities of the plate and fin exchangers during their lifetime.

In the face of these requirements, it has been noted that the existing temperature measurement solutions are not entirely satisfactory, in particular due to the complexity of the retention parts that are used or due to their implementation.

“On-site” temperature measurement methods exist, but they currently only allow the temperature inside the fluids to be measured. They are also intrusive, since they modify the flows of the fluids inside the exchange passages. Furthermore, since they are not provided from the time of construction of the exchanger, their implementation is relatively complex, expensive and not very robust.

Methods exist for measuring heat flows, but they involve inserting a probe between the passages of the exchanger. It is no longer possible to braze the exchanger as one part, which means that it loses most of its advantages. Furthermore, the probe also represents a significant additional cost and necessarily adds a thermal resistance that is not compatible with the typical heat exchange coefficients of the considered exchangers. Finally, this solution is difficult to contemplate on an industrial scale, once the exchangers have a significant number of passages, in particular due to the difficulty of assembly.

Furthermore, a heat exchanger is known from document JP-A-2014169809 that comprises a temperature probe that is inserted into a tube, the tube itself being inserted into grooves made in a plate of the exchanger. The tube is brazed between two plates, then the probe is introduced into the tube. This method poses several problems. The presence of the tube necessarily increases the thermal resistance between the plate, the temperature of which is intended to be measured, and the probe, which degrades the precision of the measurement. The tube also increases the space required for introducing the probe, which increases the intrusive nature of the method.

### SUMMARY

The particular aim of the present invention is to overcome all or some of the aforementioned problems, by proposing a method for manufacturing a brazed plate heat exchanger allowing measurements of local temperatures and/or of thermal flows to be taken inside the exchanger in a more precise manner, both in terms of the measured value and of the position in the exchanger, and without disrupting the operation of the exchanger, nor increasing its spatial requirement.

To this end, the subject matter of the invention is a method for manufacturing a heat exchanger of the brazed plate and fin type, comprising the following steps:

a) stacking, with spacing, a set of plates parallel to each other and in a longitudinal direction so as to define, between said plates, a plurality of passages adapted for the flow, in the longitudinal direction, of a first fluid to be brought into a heat exchange relationship with at least one second fluid, said plates being demarcated by a pair of longitudinal edges extending in the longitudinal direction and a pair of lateral edges extending in a lateral direction perpendicular to the longitudinal direction;

b) forming at least one of the plates stacked in step a) by overlaying, in a stacking direction perpendicular to the longitudinal and lateral directions, at least one first flat product and one second flat product one on top of the other, at least one of the first and second flat products comprising at least one groove extending parallel to the plates and emerging towards the outside of the stack via at least one opening of a lateral or longitudinal edge;

c) arranging at least one detachable shim in the groove;

d) brazing the set of plates, including the first flat product, onto the second flat product;

e) removing the detachable shim from the groove via the opening;

f) introducing at least one temperature probe into the groove.

Depending on the case, the exchanger according to the invention can comprise one or more of the following features:
the first flat product comprises a first pair of opposite surfaces and the second flat product comprises a second pair of opposite surfaces, the first flat product comprising at least one groove emerging at the opposite surface of the surfaces of the first pair that is oriented towards the second flat product;
the second flat product comprises at least one groove arranged facing said at least one groove of the first flat product and emerging at the opposite surface of the surfaces of the second pair that is oriented towards the first flat product;
in step b), said at least one plate is formed by overlaying a first flat product, a second flat product and at least one additional fiat product one on top of the other, the second flat product being arranged between the first flat product and said additional flat product;
the second flat product comprises at least one groove emerging, on the one hand, at the opposite surface of the surfaces of the second pair that is oriented towards the first flat product and emerging, on the other hand, at the opposite surface of the surfaces of the second pair that is oriented towards the additional flat product;
the second flat product comprises at least two grooves arranged at different heights in the stacking direction, one of the two grooves emerging at the surface of the second pair that is oriented towards the first flat product and the other one of the two grooves emerging at the surface of the second pair that is oriented towards the additional flat product;
the grooves of the pair are offset in relation to each other in a plane parallel to the plates;
recesses are made in the first flat product and/or the second flat product on either side of said at least one groove;
bosses are provided on the internal wall of said at least one groove so as to locally reduce the transverse section of the groove;
said at least one groove emerges, on the one hand, via an opening of a longitudinal or lateral edge and, on the other hand, via an opening of the opposite longitudinal or lateral edge, preferably said openings are arranged on two opposite longitudinal edges;
at least one of the first and second flat products comprises at least a plurality of grooves joining at the opposite longitudinal or lateral edge (4b) in order to emerge via a common opening, preferably the grooves have, as a longitudinal section in a plane parallel to the plates, a profile having at least one curvilinear shaped portion;
the first flat product and the second flat product comprise, on at least one of the opposite surfaces thereof, a coating or a sheet of a brazing agent with a predetermined melting temperature, the detachable shim being fully or partly formed from a first material having a melting temperature that is greater than said predetermined temperature or the detachable shim being fully or partly covered with a coating product configured to form, in step d), a diffusion barrier of the brazing agent in the first material of the detachable shim;
step e) comprises at least one of the following sub-steps: i) applying a traction force to the detachable shim so as to impose a translation movement thereon towards the outside of the stack; ii) imposing a torsion movement on the detachable shim so as to cause a deformation of at least one portion of the detachable shim; iii) heating or cooling the detachable shim;
after or at the same time as step f), a second material is introduced into the groove, then the second material is melted so as to fill at least part of the space around the temperature probe, preferably the second material has a melting temperature that is less than or equal to 500° C., preferably less than or equal to 200° C., more preferably less than or equal to 100° C.

Furthermore, the invention relates to a heat exchanger of the brazed plate and fin type comprising a set of plates parallel to each other and in a longitudinal direction so as to define, between said plates, a plurality of passages adapted for the flow of a first fluid to be brought into a heat exchange relationship with at least one second fluid, said plates being demarcated by a pair of longitudinal edges extending in the longitudinal direction and a pair of lateral edges extending in a lateral direction perpendicular to the longitudinal direction, at least one of the plates being formed by at least one first flat product and one second flat product brazed and overlaid one on top of the other in a stacking direction perpendicular to the longitudinal and lateral directions, at least one of the first and second flat products comprising at least one groove extending parallel to the plates and emerging towards the outside of the stack via at least one opening of a lateral or longitudinal edge, preferably via at least one opening of a longitudinal edge, with at least one temperature probe being arranged in the groove, with a second material having a melting temperature that is less than or equal to 500° C., preferably less than or equal to 200° C., more preferably less than or equal to 100° C., being arranged around at least part of the probe, said groove being devoid of any other means for retaining said probe in the groove.

In particular, said at least one plate can be formed by overlaying a first flat product, a second flat product and at least one additional flat product one on top of the other, the second flat product being arranged between the first flat product and said additional flat product, the second flat product comprising at least two grooves arranged at different heights in the stacking direction, with each groove comprising at least one probe, one of the two grooves emerging at the surface of the second pair that is oriented towards the first flat product and the other one of the two grooves emerging at the surface of the second pair that is oriented towards the additional flat product.

Furthermore, at least one of the first and second flat products can comprise at least two grooves emerging on opposite lateral or longitudinal edges, each groove being inclined by an angle ranging between 0° and 90°, preferably between 10° and 80°, in relation to the lateral or longitudinal edge on which said groove emerges.

### BRIEF DESCRIPTION OF THE DRAWINGS

The present invention will now be better understood by virtue of the following description, which is provided solely by way of a non-limiting example and with reference to the attached figures, in which:

FIG. 1 is a three-dimensional view of a brazed plate exchanger that can be manufactured using a method according to the invention;

FIG. 2 schematically shows various embodiments of flat products and of grooves according to the invention;

FIG. 3 schematically shows other embodiments of flat products and of grooves according to the invention;

FIG. 4 schematically shows other embodiments of flat products and of grooves according to the invention;

FIG. 5 schematically shows other embodiments of flat products and of grooves according to the invention;

FIG. 6 schematically shows a flat product comprising a plurality of grooves according to one embodiment of the invention;

FIG. 7 schematically shows a flat product according to another embodiment of the invention.

### DETAILED DESCRIPTION OF PREFERRED EMBODIMENTS

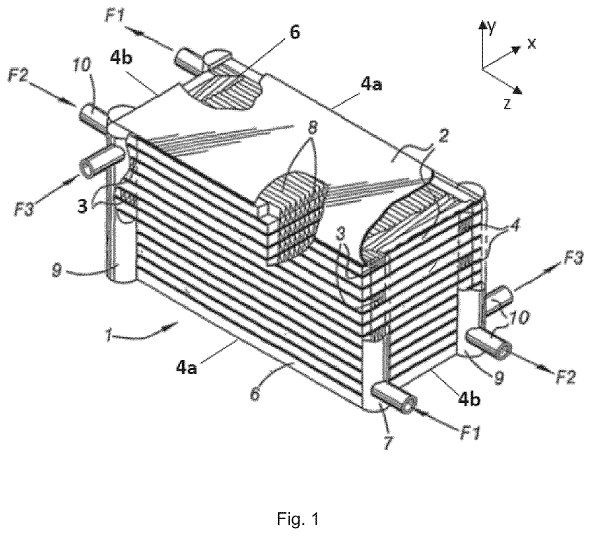

FIG. 1 shows a heat exchanger 1 of the brazed plate and fin type that comprises a stack of plates 2 that extend in two dimensions, length and width, respectively following the longitudinal direction z and the lateral direction x. The plates 2 are disposed one on top of the other, parallel to each other, and with a spacing. They thus together form a plurality of sets of passages 3, with some passages being provided for the flow of a first fluid F1 and other passages being provided for the flow of at least one other fluid F2, F3 to be brought into an indirect heat exchange relationship with F1 via the plates 2. The lateral direction x is orthogonal to the longitudinal direction z and parallel to the plates 2. The fluids preferably flow in the length of the exchanger parallel to the longitudinal direction z.

Preferably, each passage has a flat and parallelepiped shape. The gap between two successive plates 2, corresponding to the height of the passage, measured in the stacking direction y of the plates 2, is low in view of the length and the width of each successive plate. The stacking direction y is orthogonal to the plates.

The passages 3 are bordered by closure bars 6, which do not completely obstruct the passages, but leave free openings for the input or the output of the corresponding fluids. The plates 2 are demarcated by peripheral edges 4, which are preferably parallel in pairs. The peripheral edges 4 comprise a pair of longitudinal edges 4a extending in the longitudinal direction z and a pair of lateral edges 4b extending in the lateral direction x.

The exchanger 1 comprises semi-tubular shaped manifolds 7, 9 provided with inputs and outputs 10 for introducing fluids into the exchanger 1 and for discharging fluids out of the exchanger 1. These manifolds have openings that are narrower than the passages. Distribution zones arranged downstream of the input manifolds and upstream of the output manifolds are used to homogeneously channel the fluids to or from the entire width of the passages.

Preferably, at least one portion of the passages 3 comprises finned spacing elements 8 that advantageously extend along the width and the length of the passages of the exchanger, parallel to the plates 2. In the illustrated example, the spacing elements 8 comprise heat exchange undulations in the form of corrugated sheets. In this case, “fins” refer to the undulation legs that connect the successive peaks and bases of the undulation. The spacing elements 8 can also assume other particular shapes that are defined according to the desired fluid flow features. More generally, the term “fins” covers blades or other secondary heat exchange surfaces, which extend from the primary heat exchange surfaces, i.e. the plates of the exchanger, into the passages of the exchanger.

When manufacturing the exchanger 1, a set of plates 2 is provided stacked parallel to each other and to the longitudinal direction z. The plates 2 are spaced apart from each other by the closure bars S. Following the assembly of the other constituent elements of the exchangers, in particular the exchange undulations, the distribution undulations, etc., the stack is brazed in order to secure the elements of the exchangers together. Preferably, the plates and all or some of the other constituent elements of the exchanger are made of aluminium or of aluminium alloy.

According to the invention, at least one of the plates 2 of the exchanger is formed by overlaying at least one first flat product 21 and one second flat product 22 one on top of the other. The first and second flat products 21, 22 are brazed together and with the other plates 2, which are also brazed together. Preferably, the plate 2 formed by overlaying flat products and the other plates 2 of the exchanger are brazed simultaneously. It is also possible to contemplate brazing flat products together, then stacking them with the other plates 2 and proceeding with the brazing of this stack.

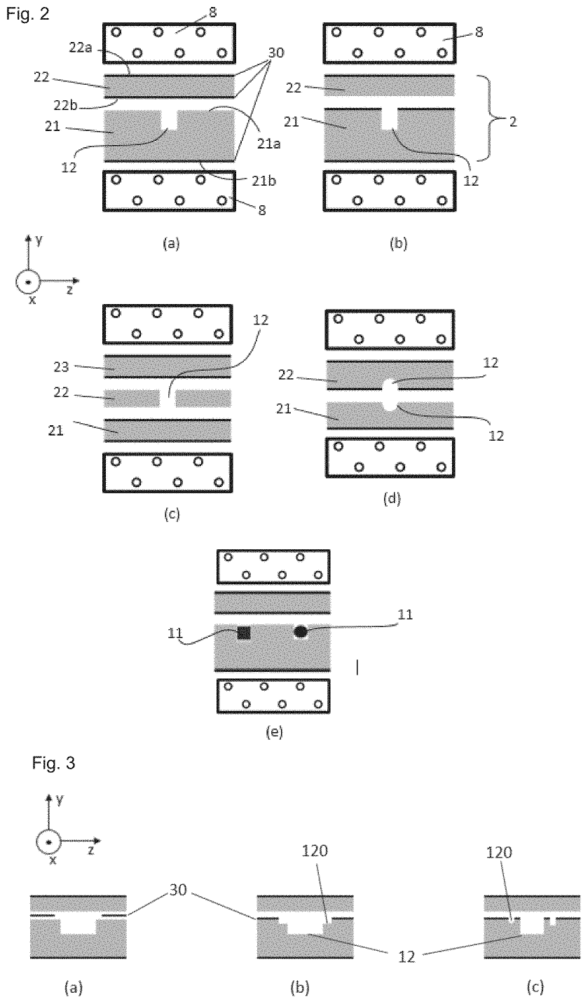

As can be seen in the examples of FIG. 2, at least one of the first and second flat products 21, 22 comprises at least one groove 12. A groove is also understood to be a furrow, a slot or a recess made in the thickness of the plate 2. The groove 12 extends parallel to the plates 2 and emerges towards the outside of the stack via at least one opening 5 located on a lateral or longitudinal 4a, 4b edge of the first flat product or of the second flat product, depending on the flat product in which the groove is provided. When the first flat product and the second flat product are overlaid, the groove 12 forms a cavity inside the plate 2 resulting from the set 21, 22 that is configured to subsequently accommodate at least one temperature probe 14. It is to be noted that FIGS. 2 to 5 show perforated straight undulations 8 arranged in the passages of the exchangers located on either side of the plate 2. Of course, any type of undulation can be contemplated, in particular non-perforated straight undulations, “herringbone” undulations, which are also called “wavy” undulations, partial offset undulations, etc.

Within the scope of the present invention, the temperature probe 14 can be any probe configured to take temperature measurements through contact. In particular, the temperature probe 14 can be a resistance temperature probe, for example, a resistance probe, in particular a platinum resistance probe of the PT100 type, or even a thermocouple or thermistor temperature probe. It is to be noted that the probe 14 introduced into the groove means at least the heat sensitive part of a sensor system, in particular the resistive circuit in the case of a resistance measurement or the measurement junction between the two conductive wires of a thermocouple, which junction is also called hot weld. The other elements of the sensor required for taking a measurement, in particular an electrical power supply device, an electrical voltage measurement device, are arranged outside the stack and are connected to the probe 14 by suitable conductive wires, such as copper wires, a thermocouple or extension cables. In the case of a thermocouple temperature probe 14, the probe 14 can comprise two electrical conductive wires soldered at one end in order to form the measurement junction, with the wires being arranged in the groove 12 in a bare state or in a protective sheath, of generally cylindrical shape.

During brazing, the constituent elements of the exchanger are connected by brazing with the use of a filler metal, called brazing or brazing agent 30, with a predetermined melting temperature. Preferably, the predetermined melting temperature ranges between 550 and 900° C., more preferably between 550 and 650° C.

The assembly is obtained by melting and diffusing brazing agent 30 inside the parts to be brazed, without melting them. The brazing agent 30 can be in the form of deposited coating layers, generally by co-laminating or optionally in the form of a liquid coating or of a gel deposited by hand onto surfaces of the plates or in the form of sheets or strips disposed between the plates. The plates, the fin spacing elements and the other constituent elements of the exchanger are pressed against each other by a compression device applying a compression force to the plates 2, which force typically ranges between 20,000 to 40,000 N/m². The stack is introduced into a vacuum furnace and is brazed at temperatures that can range between 550 and 900° C., preferably that can range between 550 and 650° C.

In order to prevent the brazing agent 30 from filling the groove 12 during melting, at least one detachable shim 11 is arranged in the groove 12. It is to be noted that the detachable shim 11 can be placed in the groove 12, either before overlaying the flat products or once the flat products are overlaid, via the opening 5. Preferably, the shim 11 is placed in the groove after the flat products have been stacked and kept damped against each other by a compression force, with a view to the subsequent brazing of the stack. This will ensure that the flat products are fully in contact with each other before the shim is introduced and this avoids moving a stacking element during the insertion of the shim 11, which could compromise the integrity of the brazed matrix and, as a result, the operation of the exchanger. This also makes it possible to verify that the dimensions of the shim are not excessive in relation to the dimensions of the groove.

It is to be noted that if there are several grooves 12, at least one detachable shim 11 can be provided per groove 12. The detachable shims can be separate from each other or even all or some of the shims are connected together, for example, like a comb, the teeth of which would form the shims, with the common part connecting the teeth being arranged outside the stack.

The plates 2 are brazed with the detachable shim 11 placed in the groove 12. Preferably, the detachable shim 11 is fully or partly formed from a first material with a melting temperature that is greater than said predetermined temperature. Thus, the detachable shim 11 is not brazed with the flat products and subsequently can be easily removed, which reduces the risk of damaging or deforming the fiat products between which it was inserted. For example, the first material can be an iron alloy, such as stainless steel. The brazing agent 30 preferably is aluminium or an aluminium alloy,

Alternatively, or additionally, the detachable shim 11 can be fully or partly covered with a coating product configured to form, in step d), a diffusion barrier of the brazing agent 30 in the first material of the detachable shim 11. This allows the removal of the shim to be facilitated by limiting the adhesion of the brazing. Thus, the method can comprise a step in which the shim 11 is covered with a product, such as STOP-OFF® or boron nitride, preventing or limiting the brazing during the brazing phase.

It is also possible to contemplate a detachable shim 11 comprising an internal part formed by a second material and an external part formed from the first material, with the second material having a melting temperature below the melting temperature of the first material. The external part acts as an insulator preventing brazing the internal part to the adjacent flat products. Thus, a greater degree of freedom is available with respect to the selection of the material of the internal part, which optionally can have a melting temperature that is less than or equal to the predetermined melting temperature. For example, the external part can be formed by an iron alloy, in particular stainless steel. The internal part can be formed by aluminium or by an aluminium alloy.

The detachable shim 11 can be a solid or hollow part, in the form of a rod or a tube and can have different transverse section shapes, in particular circular, square, hexagonal, etc.

After assembling the stack by brazing, the detachable shim 11 is removed from the groove 12 via the opening 5 and a temperature probe 14 is introduced into the groove 12, the space of which has been left free by virtue of the removal of the shim 11. The temperature probe 14 can be introduced directly into the groove, without having to use an intermediate retention part between the probe and the first and second flat products. This minimizes the thermal resistance between the probe and the flat products, which significantly improves the precision of the measurement. Furthermore, brazing the first and second flat products together ensures excellent contact from the thermal perspective and minimizes the thermal resistance between these two elements, which avoids adversely affecting the performance capabilities of the exchanger during operation. The temperature probe is non-intrusively introduced into the exchanger. The probe is included in a plate 2 of the exchanger, which allows a local temperature to be measured in the exchanger. The spatial requirement of the device is also minimized.

FIG. 2 shows various embodiments of flat products and of grooves. The grooves 12 particularly can have, as a transverse section in a plane orthogonal to the longitudinal direction z, square, rectangular or semi-circular shaped transverse sections.

The shape of the grooves can be adapted as a function of the shape of the probe 14 to be housed. It is also possible to adapt the depth of the grooves 12 and/or the thickness of the flat products in order to adapt to the dimensions of the probe 14 and to place the probe 14 at a predetermined height inside the plate 2, with the height being measured parallel to the stacking direction y.

The flat products together form a plate 2 and spacing elements 8 are arranged in the fluid passages formed on either side of the plate 2. The first flat product 21 comprises a first pair of opposite surfaces 21a, 21b and the second flat product 22 comprises a second pair of opposite surfaces 22a, 22b. These surfaces are only indicated in FIG. 2(a) for the sake of simplicity.

Preferably, a brazing agent 30 is arranged between the plates 2, as well as between the flat products.

Preferably, at least the surfaces of the flat products oriented towards the spacing elements 2 and at least one of the surfaces of a flat product oriented towards the other flat product comprise a brazing agent 30. It is also possible that the two surfaces of the flat products arranged facing each other comprise a brazing agent 30.

FIG. 2(a) illustrates the case of a first flat product 21 comprising a groove 12 emerging at the surface 21a of the first pair oriented towards the second fiat product 22. The brazing agent 30 is disposed on the surface 22b of the second product 22 oriented towards the groove 12. According to another possibility illustrated in FIG. 2(b), the brazing agent 30 is disposed on the surface 21a where the groove 12 emerges. In this case, having brazing agent 30 in the vicinity of the groove 12 is preferably avoided in order to limit the amount of brazing agent entering the groove 12 during brazing. If the first flat part is coated with brazing agent, then machining the groove on this surface allows the brazing agent to be removed. If the brazing agent is in the form of a sheet placed between the two flat products, this sheet is arranged to ensure that it does not extend opposite the groove 12.

FIG. 2(e) illustrates square or circular section shims 11.

According to one possibility, illustrated in FIG. 2(d), the second flat product 22 can also comprise at least one groove 12 arranged facing said at least one groove 12 of the first flat product 21 and emerging at the surface 22b of the surfaces of the second pair oriented towards the first flat product 21. Advantageously, the two grooves 12 have a semi-circular shaped transverse section. Such a configuration is particularly adapted to the installation of a cylindrical shaped probe 14.

FIG. 2(d) illustrates the case whereby the plate 2 in which the temperature measurement is taken is formed by overlaying a first fiat product 21, a second fiat product 22 and an additional flat product 23 one on top of the other. The second flat product 22 is arranged between the first flat product 21 and the additional flat product 23.

According to one embodiment, the second flat product 22 comprises a through-groove 12. This allows precise control of the symmetrical positioning of the probe in the plate when wishing to measure the temperature at the centre of the plate 2.

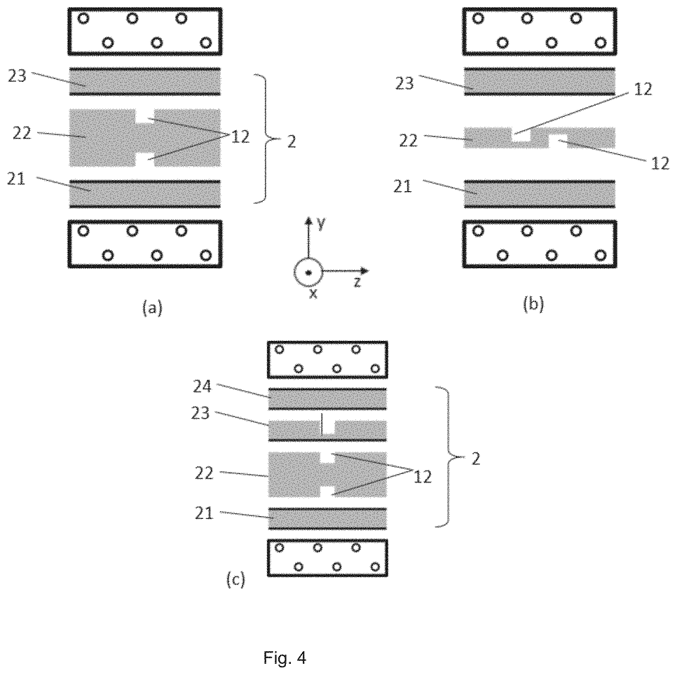

According to another embodiment, illustrated in FIG. 4, the second flat product 22 comprises at least two grooves 12, one of which emerges at the surface 22b of the second pair oriented towards the first flat product 21 and the other one of which emerges at the surface 22a of the second pair oriented towards the additional flat product 23. This allows two temperature probes 14 to be installed at different heights inside the plate 2. Based on the difference in the temperatures measured by each of the probes, it is possible to deduce the thermal flow passing through the plate 2, with the plate 2 acting as thermal resistance. Preferably, the two grooves 12 are disposed on either side and at an equal distance from the median plane of the plate 2, i.e. the plane that is parallel to the plates 2 of the stack and that is arranged, in the stacking direction y, halfway up the plate 2 formed by the stack of flat products 21, 22, 23. The probes that are subsequently arranged are also positioned in this way. This allows the temperature difference that is generated through the plate to be measured, which directly or indirectly leads to the thermal flow passing through the plate being determined.

The thickness of the second flat product 22, in which the probes are inserted, the distance between the probes and their precision can be selected in order to correspond to the desired measurement position and sensitivity.

According to one possibility, shown in FIG. 4(a), the grooves 12 of the pair of grooves are coincidentally arranged one above the other, but at different heights inside the plate 2. The probes 14 that are subsequently inserted are thus positioned facing each other. The temperature difference between the two probes then is a function of the thermal flow perpendicular to the median plane.

According to another possibility, shown in FIG. 4(b), the grooves 12 are offset in relation to each other in a plane parallel to the plates 2. This allows a thinner second flat product to be used and therefore allows the thermal resistance of the second flat product to be limited and any impact on the performance of the exchanger to be avoided.

According to another possibility, shown in FIG. 4(c), it is possible to arrange more than two probes 14 at different heights inside the plate formed by the flat products, using a plurality of additional flat products. In fact, as many additional flat products as there are desired additional probes are added to the stack. This allows the thermal gradient to be measured with more than two measurement points, which further improves the precision of the measurement. This arrangement is also more robust and makes it possible to detect if one of the probes is faulty.

Thus, in the example of FIG. 4(c), two additional flat products 23, 24 are overlaid on the second flat product 22. One of the additional flat products 23, 24 comprises at least one groove 12 emerging towards the other one of the additional products 23, 24. This overlaying mode allows three (3) probes to be arranged one on top of the other.

FIG. 3 schematically shows other possible arrangements of flat products that are overlaid to form a plate 2 according to the invention. As shown in FIGS. 3(b) and (c), recesses 120, such as cuttings or slots, can be made in the first flat product 21 and/or the second flat product 22 on either side of said at least one groove 12. This allows, during the brazing phase, any excess brazing to be collected and thus allows the integrity of the housings provided for the probes to be maintained.

In the event that the brazing agent is not co-laminated on the flat products, the brazing agent can only be arranged at a certain distance from the groove 12, as shown in FIG. 3(a). If the flat products are already covered with brazing agent, the production of the groove 12 can include a step of removing the brazing agent over a certain distance on either side of the groove.

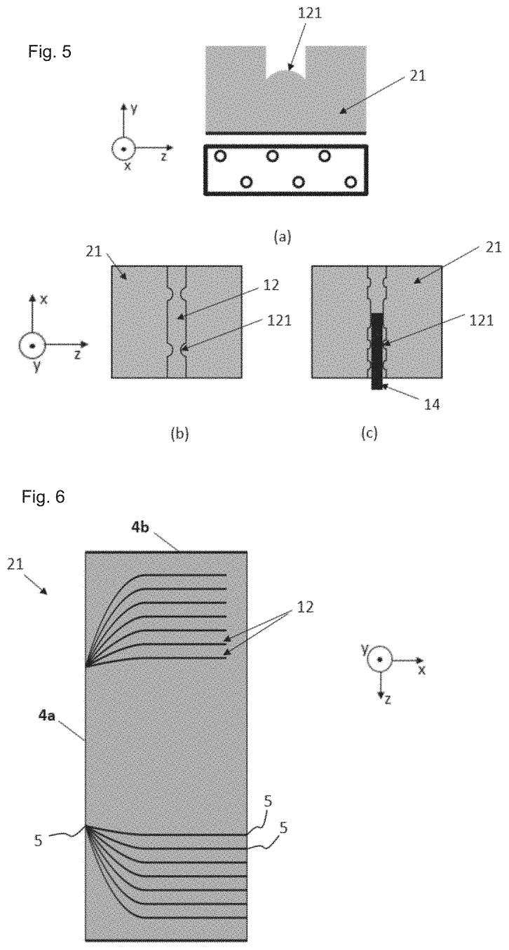

FIG. 5 schematically shows embodiments in which bosses 121 are provided on the internal wall of a groove 12 so as to locally reduce the transverse section of the groove 12. This makes it easier to slide the probe during its introduction by reducing the contact surface between the probe and the internal wall of the groove. This also facilitates the removal of the detachable shim 11 after brazing. It is to be noted that it is also possible to contemplate that at least one surface portion of the internal wall has asperities.

Since these local contractions can reduce the thermal contact between the probe and the plate, they can be locally removed in the zone where the temperature must be measured, in order to improve the representativeness of the measurement. The bosses also can be exaggerated in the zones where thermal insulation is preferable, for example, due to the fact that the plate 2 has, in this zone, a much different temperature to that intended to be measured.

It is to be noted that said at least one groove 12 can emerge either via a single opening located on an edge of the plate 2 or, on the one hand, via an opening 5 of a longitudinal 4a or lateral 4b edge and, on the other hand, via an opening 5 of the opposite longitudinal 4a or lateral 4b edge. Preferably, said openings 5 are arranged on two opposite longitudinal edges 4a. Thus, the groove 12 passes through regions with substantially equal temperatures, which avoids locally disrupting the temperature field by the addition of heat by the probe itself.

It is also possible for two shims 11 to be arranged in the groove 12, with each shim being removed via one of the openings 5, and/or for two probes 14 to be placed in the groove 12, with each probe being inserted via one of the openings 5.

If one and/or the other flat product comprises a plurality of grooves, each one can emerge on at least one of the edges of the exchanger via a separate respective opening. It is also possible for the grooves 12 to meet at the opposite longitudinal 4a or lateral 4b edge in order to emerge via a common opening 5. This is shown in FIG. 6. The grooves can stop inside the plate 2 (on the left-hand side of the plate) or otherwise emerge via a plurality of distinct respective openings 5 disposed along the opposite edge (on the right-hand side of the plate).

FIG. 6 schematically shows possible profiles of grooves 12 as a longitudinal section in a plane parallel to the plates 2. Preferably, each groove comprises a rectilinear portion. Each groove can comprise a plurality of rectilinear portions forming an angle between them, and optionally at least one curvilinear shaped portion. This allows a plurality of grooves to be consolidated at the same opening 5. The grooves 12 can be at least partly parallel to each other. Such an arrangement of a plurality of grooves allows temperatures and thermal flows to be measured at different positions in the length of the exchanger, in particular for determining where different reactions or changes of phase take place. Thus, a map is obtained of the physico-chemical phenomena that can occur in the exchanger.

During the step e) of removing the detachable shim 11, a traction force is preferably applied on the shim 11 in order to impose a translation movement thereon towards the outside of the stack. Preferably, the traction force is directed in a direction substantially parallel to the plates 2 and perpendicular to the direction of extension of the edge where the opening 5 is arranged.

The detachable shim 11 optionally can be arranged in the groove 12 so that a portion of the shim 11 exceeds the opening 5 towards the outside of the stack. Thus, the portion that extends beyond the considered edge forms a manual or mechanical gripping portion that facilitates removal.

It is also possible to impose a torsion movement onto the detachable shim 11 so as to cause a deformation of at least one portion of the detachable shim 11. The deformation of the shim allows the transverse section to be reduced and therefore allows its extraction to be facilitated. A hollow tube in the form of a shim 11 is preferably used.

The detachable shim 11 can be deformable, which facilitates the translation movement and the removal, thus reducing the risk of damaging or of deforming the plate 2 in which it was inserted.

Preferably, the detachable shim 11 is configured to fully or partly undergo plastic deformation, i.e. irreversible deformation. This further facilitates the removal of the supporting component, since it is then not necessary for the torsion to be continuously applied.

The removal step can also comprise a step of heating the detachable shim 11. In particular, the shim can be significantly and locally heated by circulating an electric current therethrough. The heat results in the dilation of the shim with subsequent cooling, which generates the play required for the shim to move in the groove 12. The heat can also locally re-melt the brazing, which would have seized to the shim during brazing.

The removal step can also comprise a step of cooling the detachable shim 11, which generates, by differential contraction, the play required for the shim to move in the groove 12.

It is also possible to contemplate, during step d), bringing the shim 11 into contact with a product configured to dissolve the constituent material of the shim. However, said product is configured so as not to dissolve the material forming the plates 2.

It is to be noted that, preferably, the height of the shim 11 before the removal step is such that it extends into practically all, even all, of the height of the groove 12 in the stacking direction y, so that no or practically no play exists between the component 11 and the adjacent plates 2. This allows the introduction of brazing into the groove 12 during brazing to be limited.

Optionally, after or at the same time as the temperature probe 14 is introduced into the groove 12, at least one element, such as a wire, can be introduced therein that is formed by a second material with a relatively low melting temperature, i.e. less than or equal to 500° C., preferably less than or equal to 200° C., more preferably less than or equal to 100° C. The second material can be selected from metals or metal alloys containing at least one of the following metals Indium, Bismuth, Tin, Lead, Cadmium, Gallium. More generally, the second material can be any thermally conductive material, the use of a heat conducting glue thus can be contemplated.

The element is subsequently heated and melted around the probe, which allows good thermal contact to be provided between the exchanger and the probe, even with an uneven shaped probe or when the probe is formed by bare wires that are joined together. In other words, at least one portion of the space that is left free between the probe and the internal walls of the groove is filled with the second material.

It is also possible to contemplate pouring the second material in the liquid state around the probe 14 in the groove 12.

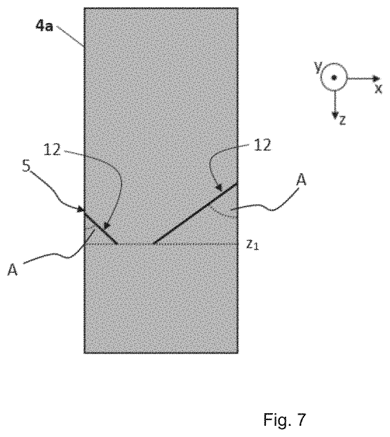

FIG. 7 schematically shows an embodiment in which one of the first and second flat products comprises at least two grooves 12 emerging on opposite lateral 4b or longitudinal 4a edges. FIG. 7 illustrates the case whereby the grooves extend towards the centre of the flat product and stop at an identical position z₁ in the length of the exchanger. It is also possible to contemplate that the grooves 12 stop at different heights. The grooves 12 are each inclined by an angle A ranging between 0° and 90° in relation to the lateral 4b or a longitudinal 4a edge on which the groove 12 emerges. Thus, it is possible, either to arrange, then melt, or directly pour, the second material into the grooves 12 located on each opposite edge all at once, without needing to turn the flat product and fill one groove after the other. This promotes the flow of the second material into the grooves. Preferably, the angle A is at least 5°, preferably ranging between 10° and 80°, more preferably ranging between 20° and 60°.

The present invention allows local thermal flows and/or local temperatures to be measured and thus allows the local heat exchange coefficient to be ascertained, which provides information relating to the local operating conditions of the heat exchangers. The method for assembling the probe is relatively simple and non-intrusive,

Of course, the invention is not limited to the particular examples described and illustrated in the present application. Other variants or embodiments within the scope of a person skilled in the art also can be contemplated without departing from the scope of the invention defined by the following claims. In particular, it should be noted that a plurality of plates 2 of the exchanger 1 can be formed by flat products and can have at least one groove 12 according to the invention, these plates can have different configurations, in particular a different number and/or different groove shapes, a different number of openings, openings arranged on different edges.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for manufacturing a heat exchanger of the brazed plate and fin type, comprising:
a) stacking, with spacing, a set of plates parallel to each other and in a longitudinal direction so as to define, between said plates, a plurality of passages adapted for the flow, in the longitudinal direction, of a first fluid to be brought into a heat exchange relationship with at least one second fluid, said plates being demarcated by a pair of longitudinal edges extending in the longitudinal direction and a pair of lateral edges extending in a lateral direction perpendicular to the longitudinal direction;
b) forming at least one of the plates stacked in step a) by overlaying, in a stacking direction perpendicular to the longitudinal and lateral (directions, at least one first flat product and one second flat product one on top of the other, at least one of the first and second flat products comprising at least one groove extending parallel to the plates and emerging towards the outside of the stack via at least one opening of a lateral or longitudinal edge;
c) arranging at least one detachable shim in the groove;
d) brazing the set of plates, including the first flat product, onto the second flat product;
e) removing the detachable shim from the groove via the opening;
f) introducing at least one temperature probe into the groove.

2. The method according to claim 1, wherein the first flat product comprises a first pair of opposite surfaces and the second flat product comprises a second pair of opposite surfaces, the first flat product comprising at least one groove emerging at the opposite surface of the surfaces of the first pair that is oriented towards the second flat product.

3. The method according to claim 2, wherein the second flat product comprises at least one groove arranged facing said at least one groove of the first flat product and emerging at the opposite surface of the surfaces of the second pair that is oriented towards the first flat product.

4. The method according to claim 1, wherein in step b), said at least one plate is formed by overlaying a first flat product, a second flat product and at least one additional flat product one on top of the other, the second flat product being arranged between the first flat product and said additional flat product.

4. The method according to claim 4, wherein the second flat product comprises at least one groove emerging, on the one hand, at the opposite surface of the surfaces of the second pair that is oriented towards the first fiat product and emerging, on the other hand, at the opposite surface of the surfaces of the second pair that is oriented towards the additional flat product.

6. The method according to claim 4, wherein the second flat product comprises at least two grooves arranged at different heights in the stacking direction, one of the two grooves emerging at the surface of the second pair that is oriented towards the first flat product and the other one of the two grooves emerging at the surface of the second pair that is oriented towards the additional flat product.

7. The method according to claim 6, wherein the two grooves are offset in relation to each other in a plane parallel to the plates.

8. The method according to claim 1, wherein recesses are made in the first flat product and/or the second flat product on either side of said at least one groove.

9. The method according to claim 1, wherein bosses are provided on the internal wall of said at least one groove so as to locally reduce the transverse section of the groove.

10. The method according to claim 1, wherein said at least one groove emerges, on the one hand, via an opening of a longitudinal or lateral edge and, on the other hand, via an opening of the opposite longitudinal or lateral edge.

11. The method according to claim 1, wherein the removal step e) comprises at least one of the following sub-steps:
i) applying a traction force to the detachable shim so as to impose a translation movement thereon towards the outside of the stack;
ii) imposing a torsion movement on the detachable shim so as to cause a deformation of at least one portion of the detachable shim;
iii) heating or cooling the detachable shim.

12. The method according to claim 1, wherein, after step f), a second material is introduced into the groove, then the second material is melted so as to fill at least part of the space around the temperature probe.

13. A heat exchanger of the brazed plate and fin type comprising a set of plates parallel to each other and in a longitudinal direction so as to define, between said plates, a plurality of passages adapted for the flow of a first fluid to be brought into a heat exchange relationship with at least one second fluid, said plates being demarcated by a pair of longitudinal edges extending in the longitudinal direction and a pair of lateral edges extending in a lateral direction perpendicular to the longitudinal direction, at least one of the plates being formed by at least one first flat product and one second flat product brazed and overlaid one on top of the other in a stacking direction perpendicular to the longitudinal and lateral directions, at least one of the first and second flat products comprising at least one groove extending parallel to the plates and emerging towards the outside of the stack via at least one opening of a lateral or longitudinal edge, preferably via at least one opening of a longitudinal edge, with at least one temperature probe being arranged in the groove, with a second material, having a melting temperature that is less than or equal to 500° C. being arranged around at least part of the probe, said groove being devoid of any other means for retaining said probe in the groove.

14. The exchanger according to claim 13, wherein said at least one plate is formed by overlaying a first flat product, a second flat product and at least one additional flat product one on top of the other, the second flat product being arranged between the first flat product and said additional flat product, the second flat product comprising at least two grooves arranged at different heights in the stacking direction, with each groove comprising at least one probe, one of the two grooves emerging at the surface of the second pair that is oriented towards the first flat product and the other one of the two grooves emerging at the surface of the second pair that is oriented towards the additional flat product.

15. The exchanger according to claim 13, wherein at least one of the first and second flat products comprises at least two grooves emerging on opposite lateral or longitudinal edges, each groove being inclined by an angle ranging between 0° and 90 in relation to the lateral or longitudinal edge on which said groove emerges.
